(19) United States
(12) Patent Application Publication
(10) Pub. No.: US 2015/0107655 A1
(43) Pub. Date: Apr. 23, 2015

(54) HIGH EFFICIENT SOLAR ENERGY COLLECTION APPARATUS

(71) Applicant: MING-CHIEH WANG, Taipei City (TW)

(72) Inventor: MING-CHIEH WANG, Taipei City (TW)

(21) Appl. No.: 14/520,377

(22) Filed: Oct. 22, 2014

(30) Foreign Application Priority Data
Oct. 22, 2013 (TW) 102219681

(51) Int. Cl. H02S 20/10

(52) U.S. Cl. CPC H02S 20/10
USPC 136/251

(57) ABSTRACT

A high efficient solar energy collection apparatus comprises a body, which is in form of half-arc and disposed on a holder, and at least one solar energy panel, which is disposed on surface of the body. This invention efficiently solves the easy-malfunctioned, great setting up space required, high power consumed and uneconomical defects existed in the conventional solar tracking apparatus.

### BACKGROUND OF THE INVENTION

1. Field of the Invention

The present invention relates to a high efficient solar energy collection apparatus which can effectively solve easy-malfunctioned, great setting up space required, high power consumed and uneconomical defects existed in the conventional solar tracking apparatus.

2. Descriptions of the Related Art

The fossil fuel is the main energy source worldwide. However, the fossil fuel is disposable energy which could be running out and causes serious air pollution with waste gas. Therefore, as the drain of earth energy and the rising awareness of environment protection, green energy resources of wind power energy, hydraulic power energy and solar energy are developed accordingly among the nations. Particularly, solar energy is the most optional and practical since the source of the solar energy has the benefits of clean, plenty and convenient without digging or refining procedures.

The collection of the solar energy is achieved by absorbing the solar energy via the solar energy panel and transforming the solar energy to the electrical energy. However, as the sun rising and sinking, the angle of incidence that the sun shines onto the solar energy panel changes, which causes the area of the surface of the solar energy panel receiving the solar light to reduce and the absorbing-utilization rate of the solar energy to decrease accordingly. Therefore, solar tracking apparatus is used for increasing the absorbing-utilization rate of the solar energy.

Please refer to FIGS. 5 to 11. Conventional solar tracking apparatus being formed in a flat structure comprises: a fixing bas 10, a pivoting unit 20, a pivoting part 30, a run-out unit 40, a holder 50, a solar energy panel 60, a sensing unit 70 and a controller 80. The fixing bas 10 is extended along an axis X (an axis Y is defined perpendicularly with the axis X) and has an assembly end 11. The pivoting unit 20 comprises a first worm gear 21, a first worm 22, a first driving motor 23 and a first driving base 24. The first worm gear 21 has first gear part 211 around and is disposed at the assembly end 11 of the fixing base 10, and central axle of the first worm gear 21 extends along the X axis. A driving axle 231 of the first driving motor 23 penetrates the first driving base 24, and the first driving motor 23 is coupled with the first diving base 24 fixedly. Side of the first driving base 24 has an open 241. The first worm 22 extends along the Y axis, is put in the first driving base 24 for connecting with the driving axle 231, and has a first driving gear part 221 around. The first driving gear part 221 of the first worm 22 is exposed from the open 241 of the driving base 24 for meshing the first gear part 211 of the first worm gear 21. Then the driving axle 231 of the first driving motor 23 drives the first worm 22 to rotate when the first driving motor 23 drives. The first worm 22 shifts around the first worm gear 21 and drives the first driving base 24 to rotate, specifically drives the first driving base 24 to pivot around the axis X. One end of the pivot part 30 assembles with the first driving base 24 of the pivot unit 20 for pivoting with the first driving base 24. The run-out unit 40 comprises a second worm gear 41, a second worm 42, a second driving motor 43 and a second driving base 44. The second worm gear 41 has a second gear part 211 around and is disposed at an end of the pivot part 30 which is opposite to the first driving base 24, and central axle of the second worm gear 41 extends along the direction which is perpendicular to the X axis. A second driving axle 431 of the second driving motor 43 penetrates the second driving base 44, and the second driving motor 43 is coupled with the second diving base 44 fixedly. The second worn 42 extends along the axis Y, is put in the second driving base 44 and for connecting with the second driving axle 431, and has a second driving gear part 421 around. The second driving gear part 421 of the second worm 42 mesh the second gear part 411 of the second worm gear 41. Then the second driving axle 431 of the second driving motor 43 drives the second worm 42 to rotate when the second driving motor 43 drives. The second worm 42 shifts around the second worm gear 41 and drives the second driving base 44 to rotate, specifically drives the second driving base 44 to shift around the second worm gear 41 and run-out against the axis X. By the small rotating angle of the direct-current motor and the ratio setting of the worm and the worm gear, it makes the second driving base 44 shift around the second worm 41 and run-out against the axis X as smaller angle. The holder 50 is disposed on the second driving base 44 fixedly. The solar energy panel 60 is disposed on the holder 50 fixedly. The sensing unit 70 is structured as a pyramid by composing of sensing surfaces 71. Each sensing surface 71 is set a light sensor 72 thereon. The controller 80 electrically connects with the light sensors 72 of the sensing unit 70, the first driving motor 23 of the pivot unit 20 and the second driving motor 43 of the run-out unit 40.

The conventional solar tracking apparatus senses the solar light continuously by the sensing unit 70. When the sensing unit 70 senses the solar light, the controller 80 determines and compares the sensing results of the light sensors 72 at the same time. The controller 80 compares the amount of sensed light of each light sensor 72 and controls the first driving motor 23 or the second driving motor 43 to operate by the comparing results so that the solar energy panel 60 can be turned to face the direction with the most sufficient solar light. Therefore, the area of the surface of the solar energy panel 60 receiving the solar light can be stabilized for raising the absorbing-utilization rate of the solar energy.

However, there are following defects existed in the conventional solar tracking apparatus:

First, easy-malfunctioned: the first driving motor 23, the second driving motor 42, the light sensors 72 and the controller 80 of the conventional solar tracking apparatus are all expensive instruments. Therefore, since the conventional solar tracking apparatus is set up outdoor and braving the wind, rain and sun, it causes the first driving motor 23, the second driving motor 43 and the light sensors 72 to malfunction. The technical staff needs to maintain them often.

Second, great setting up space required: since the tracking solar apparatus is composed of the above elements, the volume of the tracking solar apparatus is huge and uneasy to be moved. Therefore, the conventional solar tracking apparatus can only be set up in the extremely open outdoor space but cannot be set up in the small space like the balconies of residences or parks in the city.

Third, quite power consumption: the conventional solar tracking apparatus continuously senses the solar light by the sensing unit 70. The controller 80 determines and compares the sensing results of the light sensors 72, and controls the first driving motor 23 or the second driving motor 43 to operate by the comparing results so that the solar energy panel 60 can be turned to face the solar light. The above steps are complicated controlling steps which consume lot of power energy (33% of the generated electrical power at least). It is possible that the generated electrical power is not much left. Worse, the generated electrical power is not enough for the power consumption for operating the solar tracking apparatus itself. It is like putting cart before the horse.

Fourth, uneconomical: the conventional solar tracking apparatus is composed of the above expensive elements. For example, the cost of the first driving motor 23 or the second driving motor 43 is almost 45% of the cost of the conventional solar tracking apparatus. Therefore, it is uneconomical since it has the defects of high manufacturing cost, easy-malfunction, regular maintenance and great set up space requirements.

Therefore, the conventional solar tracking apparatus easy-malfunctioned, great setting up space required, high power consumed and uneconomical defects, and an improvement is in an urgent need.

### SUMMARY OF THE INVENTION

In view of that there are easy-malfunctioned, great setting up space required, high power consumed and uneconomical defects existed in the conventional solar tracking apparatus, the inventor develops a high efficient solar energy collection apparatus with related scientific theory based on years' experience in this field and long term researches and experiments.

The present invention is to provide a high efficient solar energy collection apparatus which is a solid structure. The high efficient solar energy collection apparatus comprises a body, at least one solar energy panel and a holder. The body is in form of half-arc, and the at least one solar energy panel is fixedly disposed on surface of the body. The at least one solar energy panel is used to absorb the solar energy and transform the solar energy into electrical power. The body is disposed on the holder fixedly. The holder is used to support the body. Therefore, the area for receiving the solar light can be increased substantially, and solar energy from different angles of sunrise and sunset can be received for increasing the absorbing-utilization rate of the solar energy substantially. In addition, the solar energy collection apparatus is composed of cheap elements which hardly get malfunction and work without extra electrical power. Further, the cost of the driving motors of the conventional solar tracking apparatus can be used for more solar energy panels. Therefore, the easy-malfunctioned, great setting up space required, high power consumed and uneconomical defects existed in the conventional solar tracking apparatus can be solved.

Another objective of this invention is to provide a solar energy collection apparatus can be used as a shelter which is capable of generating power for public infrastructures independently. The body is capable of being disposed a light instrument which connects with the at least one solar energy panel electrically. The at least one solar energy panel absorbs the solar energy and transforms the solar energy into electric power for supplying the light instrument to light. The solar energy collection apparatus can be fixedly disposed in park, coffee shop, beach, balcony, sidewalk and bus station etc. without considering the limitation of the wired allocation of the conventional electric power system.

### BRIEF DESCRIPTION OF THE DRAWINGS

FIG. 1 is a three dimension schematic view of the present invention;

FIG. 2 is a three dimension schematic view of the present invention being spread as a flat structure;

FIG. 3 is another three dimension schematic view of the present invention;

FIG. 4 is a three dimension view of the present invention;

FIG. 5 is a plan schematic view of the conventional solar tracking apparatus;

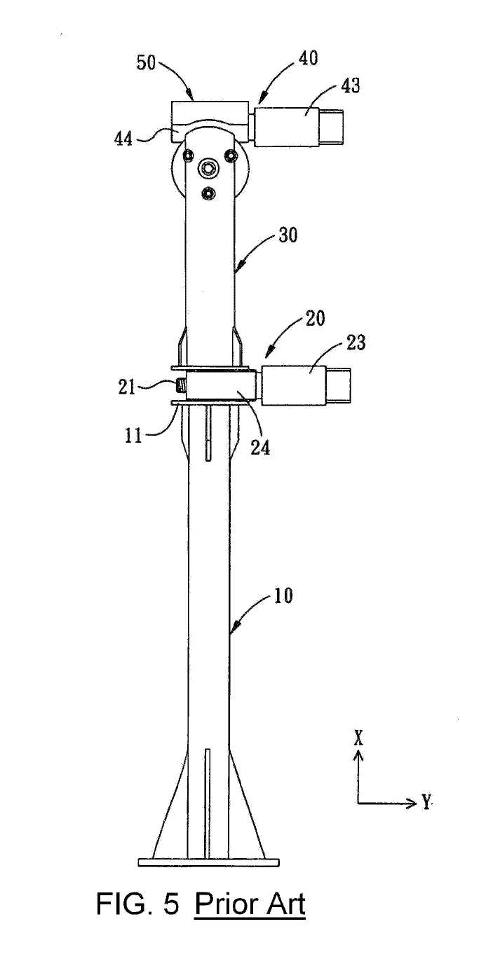

FIG. 6 is a plan view of part structure of the conventional solar tracking apparatus;

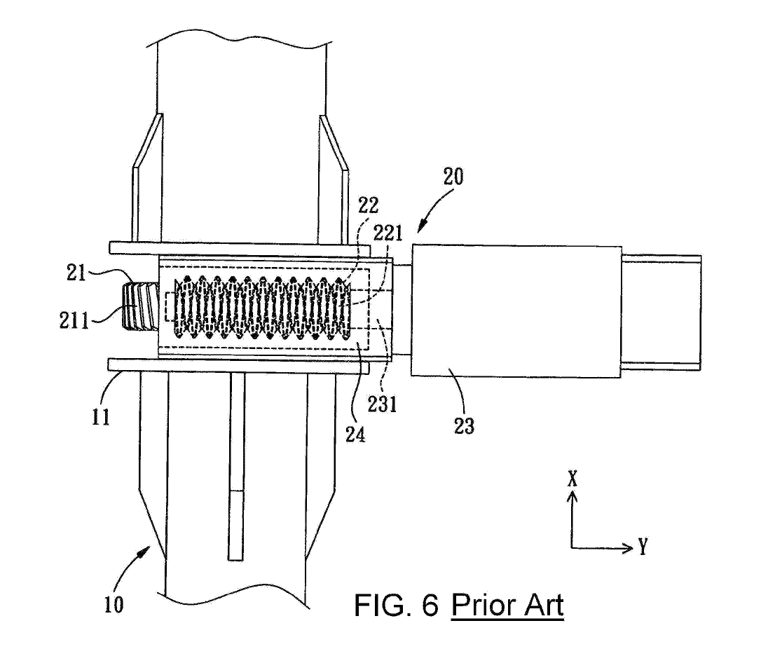

FIG. 7 is another plan view of part structure of the conventional solar tracking apparatus;

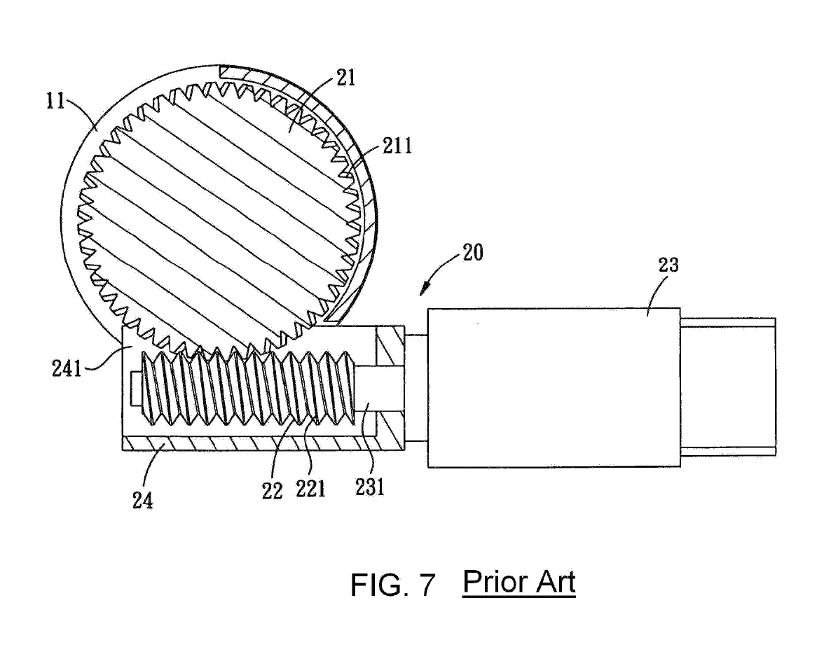

FIG. 8 is a schematic view of operating the pivot unit of the conventional solar tracking apparatus;

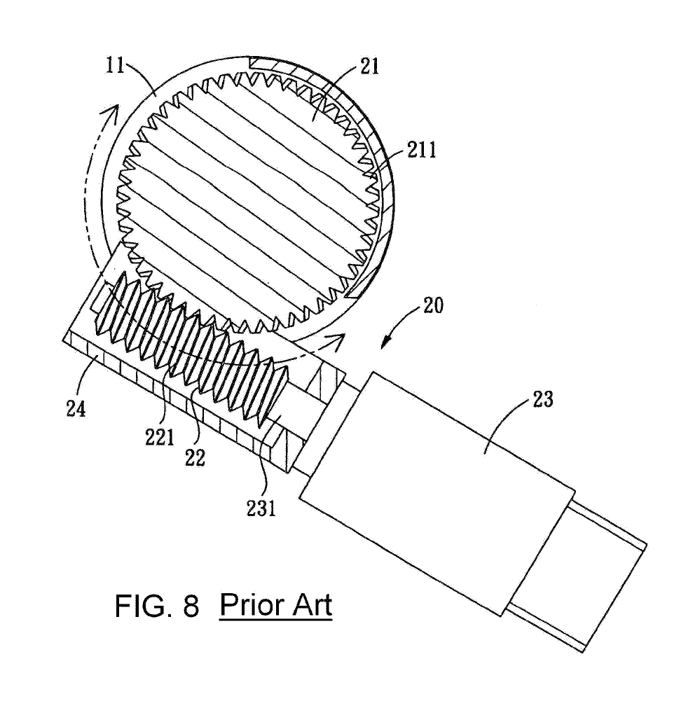

FIG. 9 is another plan view of part structure of the conventional solar tracking apparatus;

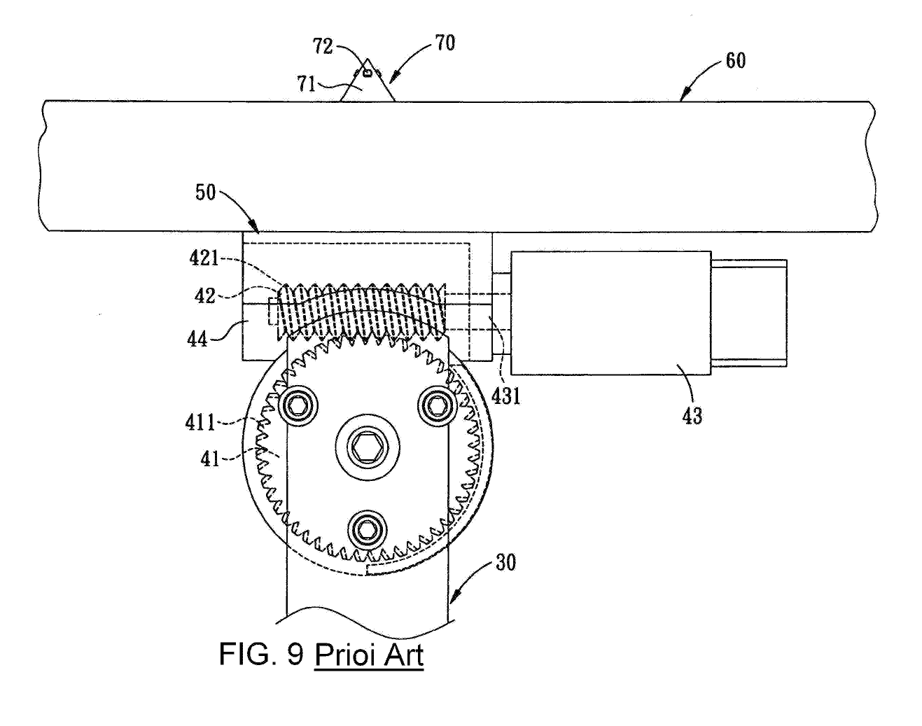

FIG. 10 is a three dimension schematic view of the sensing unit of the conventional solar tracking apparatus; and

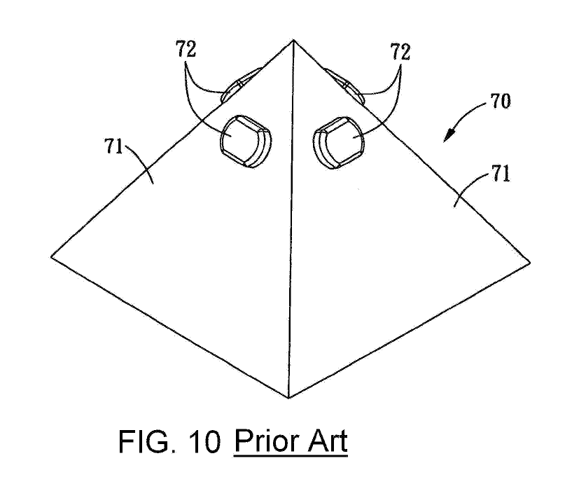

FIG. 11 is a schematic view of operating the sensing unit of the conventional solar tracking apparatus.

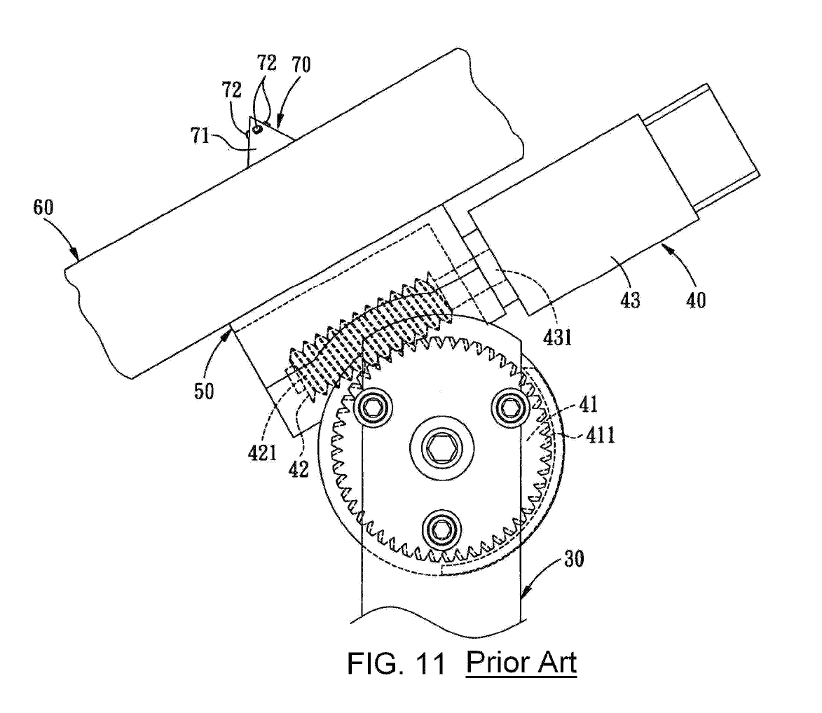

### DESCRIPTION OF THE PREFERRED EMBODIMENT

For the Examiner to further understand the technical features and the operations of the present invention easier, following embodiment is exampled with drawings. The details will be further described hereinafter.

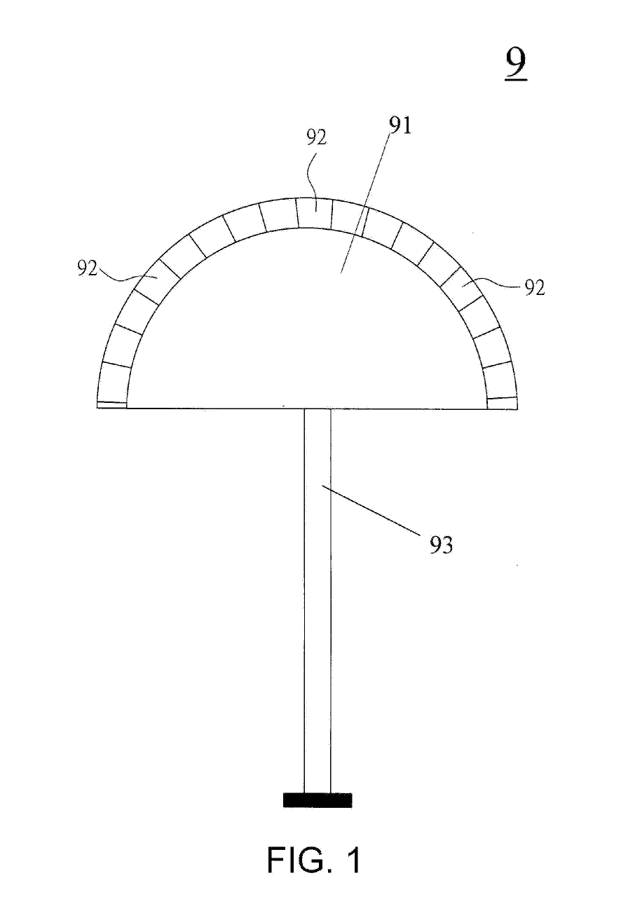

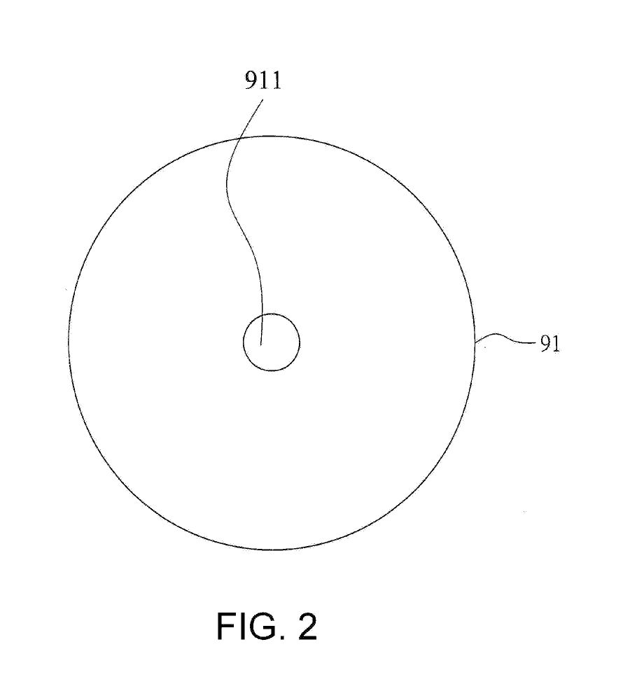

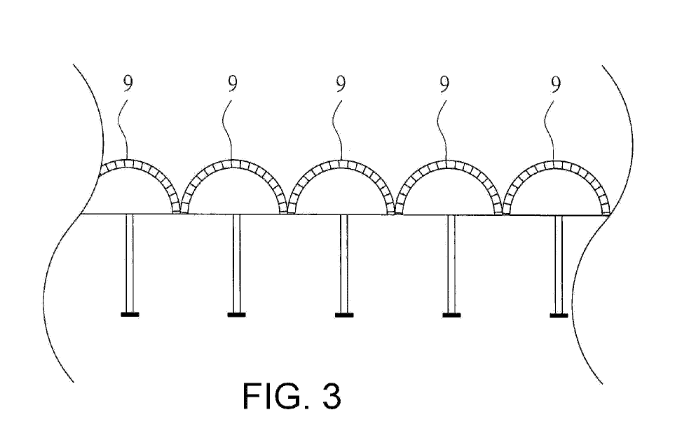

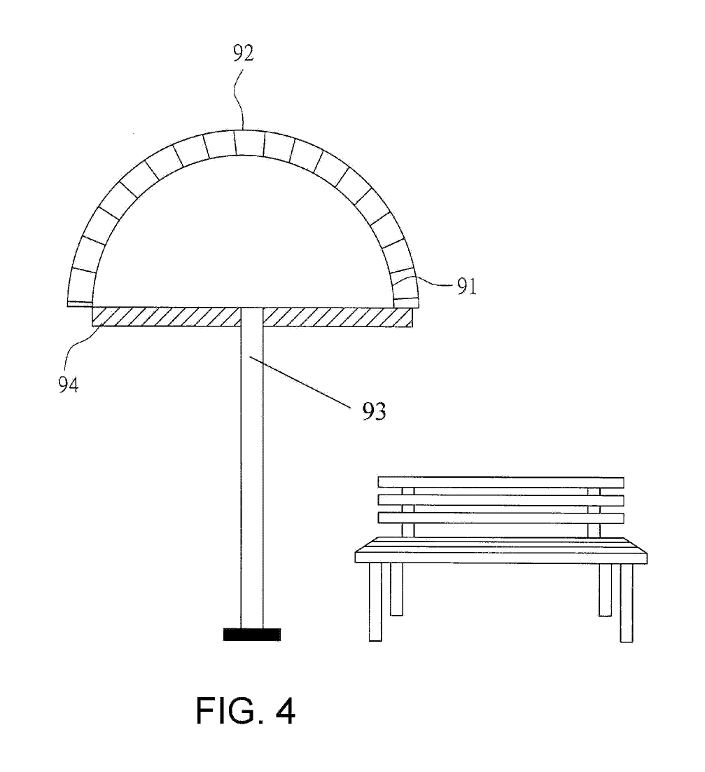

Please refer to FIGS. 1 to 4. This invention provides a high efficient solar energy collection apparatus 9 which is a solid structure. The high efficient solar energy collection apparatus 9 comprises a body 91, solar energy panels 92 and a holder 93.

The body 91 is in form of half-arc, and the solar energy panels 92 are fixedly disposed on surface of the body 91. The solar energy panels 92 are used to absorb the solar energy and transform the solar energy into electrical power. The body 91 is disposed on the holder 93 fixedly. The holder 93 is used to support the body 91.

In the present invention, the body is preferably in form of umbrella-circle.

In the present invention, the body 91 is preferably in form of half-circle. Comparing with the complete flat solar energy panel, double area of the solar energy panels 92 can be fixedly disposed on the body 91 when the body 91 is in form of half-circle. This not only increases the areas of the solar energy collection apparatus 9 for receiving the solar energy, but receives solar energy from different angles of sunrise and sunset for increasing the absorbing-utilization rate of the solar energy collection apparatus 9 substantially.

In the present invention, the body 91 is preferably has a vent 911 for keeping the air in circulation. When the solar energy collection apparatus 9 suffers strong wind, the strong wind could be circulated via the vent 911 so that the solar energy collection apparatus 9 will not be overturned while suffering the strong wind.

The solar energy collection apparatus 9 of the present invention is composed of cheap elements which hardly need maintenance. This effectively solves the easy-malfunctioned defect existed in the conventional solar tracking apparatus while using the motor, light sensors and controller such expensive instruments.

Further, the solar energy collection apparatus 9 of the present invention is composed of the small elements so that the volume is quite small and the weight is light for moving easily.

Hence, it can be set up in the balcony of the residence and park such places with smaller area. Therefore, the great setting up space required defect of the conventional solar tracking apparatus can be solved.

Moreover, the solar energy collection apparatus 9 of the present invention increases the absorbing-utilization rate by increasing the areas of the solar energy panels 92 fixedly disposed on the body and receiving the solar energy from different angles (The surface area of the body 91 is almost twice as the surface area of flat structure with same radius (4π*radius2/2=2)). The solar energy collection apparatus 9 works without extra electric power supply. Therefore, quite power consumed defect existed in the conventional solar tracking apparatus can be solved.

As described above, since the solar energy collection apparatus 9 is composed of cheap elements, the cost of manufacturing the solar energy collection apparatus 9 is low. The solar energy collection apparatus 9 hardly gets malfunction so that it doesn't need to be maintained. Further, the solar energy collection apparatus 9 only needs small space for setting up. Therefore, the uneconomical defects existed in the conventional solar tracking apparatus can be solved.

While implementing the present invention, plurality of the solar energy collection apparatus 9 can be set up side by side for absorbing the solar energy and transforming the solar energy into electric power. Despite sunrise and sunset, the solar energy panels 92 are still capable of receiving solar energy from different angles. During the period with the strongest day light (about 8:00 am to 2:00 pm), the absorbing-utilization rate of the present invention are eight time than the conventional flat solar energy panel.

In addition, in the present invention, an electric equipment can be disposed on the body 91. The electric equipment is preferably a light instrument 94 which connects to the solar energy panels 92 electrically. The electric power transformed from the solar energy that the solar energy panels 92 absorb can be directly supplied to the light instrument 94 for lighting. The solar energy collection apparatus 9 can be fixedly disposed in park, coffee shop, beach, balcony, sidewalk and bus station etc. as a shelter which is capable of generating power for public infrastructures independently without considering the limitation of the wired allocation of the conventional electric power system.

The detailed disclosures above specify one particular embodiment of the present invention. However, this embodiment is not intended to limit the claims of the present application. Variety of modifications and replacements based on the concept of the present invention should be protected under the claims of the present application.

What is claimed is:

1. A high efficient solar energy collection apparatus, comprising:
a body, being in form of half-arc and disposed on a holder; and
at least one solar energy panel, being disposed on surface of the body

2. The high efficient solar energy collection apparatus as claimed in claim 1, wherein the body is in form of half-circle.

3. The high efficient solar energy collection apparatus as claimed in claim 2, wherein top of the body has a vent.

4. The high efficient solar energy collection apparatus as claimed in claim 3, wherein the body is capable of being disposed an electric equipment which connects to the at least one solar energy panel electrically.

5. The high efficient solar energy collection apparatus as claimed in claim 4, wherein the electric equipment is a light instrument.

6. The high efficient solar energy collection apparatus as claimed in claim 1, wherein the body is in form of umbrella-circle.

7. The high efficient solar energy collection apparatus as claimed in claim 6, wherein top of the body has a vent.

8. The high efficient solar energy collection apparatus as claimed in claim 7, wherein the body is capable of being disposed an electric equipment which connects to the at least one solar energy panel electrically.

9. The high efficient solar energy collection apparatus as claimed in claim 8, wherein the electric equipment is a light instrument.
